(19) United States
(12) Patent Application Publication
(10) Pub. No.: US 2014/0022689 A1
(43) Pub. Date: Jan. 23, 2014

(54) MULTI-LAYERED CERAMIC ELECTRONIC COMPONENT AND METHOD OF MANUFACTURING THE SAME

(71) Applicants: Joon Hwan Kwag, Suwon (KR); Sang Huk Kim, Suwon (KR)

(72) Inventors: Joon Hwan Kwag, Suwon (KR); Sang Huk Kim, Suwon (KR)

(21) Appl. No.: 13/620,330

(22) Filed: Sep. 14, 2012

(30) Foreign Application Priority Data
Jul. 18, 2012 (KR) 10-2012-0078423

(51) Int. Cl. H01G 4/30

(52) U.S. Cl. 361/301.4

(57) ABSTRACT

There is provided a multilayered ceramic electronic component including: a ceramic body including a dielectric layer and having first and second main surfaces, third and fourth end surfaces, and fifth and sixth side surfaces; internal electrodes disposed to face each other in the ceramic body and having the dielectric layer interposed therebetween; and external electrodes electrically connected to the internal electrodes, wherein the external electrodes include first external electrodes formed from the third or fourth end surface to the first and second main surfaces, and second external electrodes formed from the third or fourth end surfaces to the first and second main surfaces on the first external electrodes, having a length shorter than a length to which the first external electrodes are formed on the first and second main surfaces, and containing an epoxy resin.

### CROSS-REFERENCE TO RELATED APPLICATIONS

This application claims the priority of Korean Patent Application No. 10-2012-0078423 filed on Jul. 18, 2012, in the Korean Intellectual Property Office, the disclosure of which is incorporated herein by reference.

### BACKGROUND OF THE INVENTION

1. Field of the Invention

The present invention relates to a high capacitance multi-layered ceramic electronic component capable of suppressing infiltration of a plating solution into an internal electrode to have excellent reliability, even in the case in which an external electrode is relatively thin.

2. Description of the Related Art

In accordance with the recent trend for the miniaturization of electronic products, demand for a small multi-layered ceramic electronic component having high capacitance has increased.

Therefore, a dielectric layer and an internal electrode have been thinned and multilayered through various methods. Recently, as a thickness of the dielectric layer has been reduced, a multilayered ceramic electronic component having an increased number of layers has been manufactured.

In addition, as an external electrode also has been required to be thin, a plating solution may infiltrate into an inner portion of a chip through the thinned external electrode, and thus there may be present a technical difficulty in the miniaturization process.

Particularly, in the case in which the external electrode has a non-uniform shape, a risk that the plating solution may infiltrate through a relatively thin portion thereof is further increased, such that product reliability may not be secured.

Therefore, in the case in which a high capacitance product is small, it is important to secure product reliability.

The following Related Art Document discloses features of the case in which a resistor film including a curable resin is formed on an end portion of a ceramic body, but infiltration of the plating solution through an external electrode may not be solved.

### RELATED ART DOCUMENT

Japanese Patent Laid-Open Publication No. 2007-096215

### SUMMARY OF THE INVENTION

An aspect of the present invention provides a high capacitance multilayered ceramic electronic component capable of suppressing infiltration of a plating solution into an internal electrode to have excellent reliability, even in the case in which an external electrode is relatively thinned.

According to an aspect of the present invention, there is provided a multilayered ceramic electronic component including: a ceramic body including a dielectric layer and having first and second main surfaces opposing each other in a stacking direction of the dielectric layer, third and fourth end surfaces connecting the first and second main surfaces to each other and opposing each other in a length direction, and fifth and sixth side surfaces connecting the first and second main surfaces to each other and opposing each other in a width direction; internal electrodes disposed to face each other in the ceramic body and having the dielectric layer interposed therebetween; and external electrodes electrically connected to the internal electrodes, wherein in the length-thickness cross-section of the ceramic body, the external electrodes include first external electrodes formed from the third or fourth end surface to the first and second main surfaces, and second external electrodes formed from the third or fourth end surfaces to the first and second main surfaces on the first external electrodes, having a length shorter than a length to which the first external electrodes are formed on the first and second main surfaces, and containing an epoxy resin.

The first external electrode formed on the third or fourth end surface may have an average thickness of 10 μm or less.

The first external electrode formed on the first and second main surfaces may have an average thickness of 2 to 10 μm.

The second external electrode may have an average thickness of 5 to 15 μm.

The first external electrode may contain a conductive metal having a content of 60 wt % or less based on the total weight thereof, and the conductive metal may be at least one selected from a group consisting of copper (Cu), nickel (Ni), silver (Ag), and sliver-palladium (Ag—Pd).

In the length direction of the ceramic body, when a total length of the external electrode is L and a length of the second external electrode is E, 0.05≦E/L≦0.3 may be satisfied.

The multilayered ceramic electronic component may further include a plating layer formed on the external electrode.

According to another aspect of the present invention, there is provided a multilayered ceramic electronic component including: a ceramic body including a dielectric layer and having first and second main surfaces opposing each other in a stacking direction of the dielectric layer, third and fourth end surfaces connecting the first and second main surfaces to each other and opposing each other in a length direction, and fifth and sixth side surfaces connecting the first and second main surfaces to each other and opposing each other in a width direction; internal electrodes disposed to face each other in the ceramic body and having the dielectric layer interposed therebetween; and external electrodes electrically connected to the internal electrodes, wherein in the length-thickness cross-section of the ceramic body, the external electrodes include first external electrodes formed from the third or fourth end surface to the first and second main surfaces, and second external electrodes formed on the first external electrodes and containing an epoxy resin, and when a total length of the external electrode is L and a length of the second external electrode is E, 0.05≦E/L≦0.3 may be satisfied.

The first external electrode formed on the third or fourth end surface may have an average thickness of 10 μm or less.

The first external electrode formed on the first and second main surfaces may have an average thickness of 2 to 10 μm.

The second external electrode may have an average thickness of 5 to 15 μm.

The first external electrode may contain a conductive metal having a content of 60 wt % or less based on the total weight thereof.

According to another aspect of the present invention, there is provided a method of manufacturing a multilayered ceramic electronic component including: preparing a ceramic body including dielectric layers and a plurality of internal electrodes disposed to face each other and having the dielectric layer interposed therebetween; preparing a conductive paste for an external electrode containing a conductive metal; applying the conductive paste for an external electrode to an end portion of the ceramic body to be electrically connected to the internal electrodes to thereby form first external electrodes; forming second external electrodes containing an epoxy resin on the first external electrodes; and firing the ceramic body to form the external electrodes, wherein in a length direction of the ceramic body, when a total length of the external electrode is L and a length of the second external electrode is E, 0.05≦E/L≦0.3 may be satisfied.

The first external electrode formed on the third or fourth end surface may have an average thickness of 10 μm or less.

The first external electrode formed on the first and second main surfaces may have an average thickness of 2 to 10 μm.

The second external electrode may have an average thickness of 5 to 15 μm.

The second external electrode may be formed by a dipping method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a multilayered ceramic capacitor according to an embodiment of the present invention;

FIG. 2 is a cross-sectional view taken along line B-B′ of FIG. 1;

FIG. 3 is an enlarged view of part A of FIG. 2; and

FIG. 4 is a view illustrating a manufacturing process of the multilayered ceramic capacitor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Embodiments of the present invention will now be described in detail with reference to the accompanying drawings.

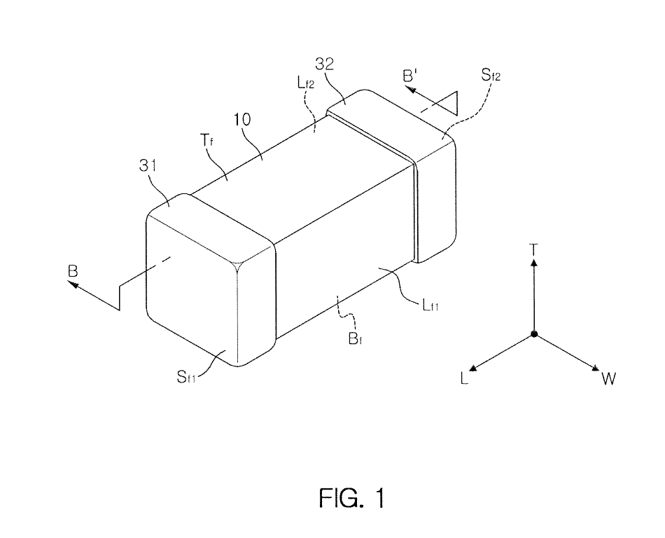

FIG. 1 is a perspective view schematically illustrating a multilayered ceramic capacitor according to an embodiment of the present invention.

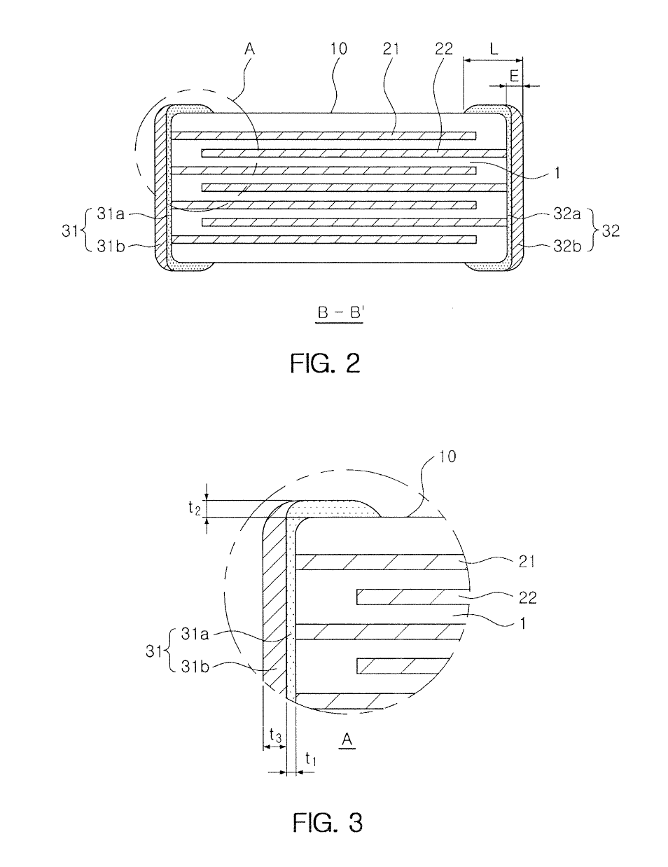

FIG. 2 is a cross-sectional view taken along line B-B′ of FIG. 1.

FIG. 3 is an enlarged view of part A of FIG. 2.

Referring to FIGS. 1 through 3, the multilayered ceramic electronic component according to the embodiment of the present invention may include a ceramic body 10 including a dielectric layer 1 and having first and second main surfaces opposing each other in a stacking direction of the dielectric layer 1, third and fourth end surfaces connecting the first and second main surfaces to each other and opposing each other in a length direction, and fifth and sixth side surfaces connecting the first and second main surfaces to each other and opposing each other in a width direction; internal electrodes 21 and 22 disposed to face each other in the ceramic body 10, having the dielectric layer 1 therebetween; and external electrodes 31 and 32 electrically connected to the internal electrodes 21 and 22, wherein in the length-thickness cross-section of the ceramic body, the external electrodes 31 and 32 include first external electrodes 31a and 32a formed from the third or fourth end surface to the first and second main surfaces, and second external electrodes 31b and 32b formed from the third or fourth end surface to the first and second main surfaces on the first external electrodes 31a and 32a, having a length shorter than a length to which the first external electrodes are formed on the first and second main surfaces, and containing an epoxy resin.

One ends of the first and second internal electrodes 21 and 22 may be alternately exposed to the third and fourth end surfaces of the ceramic body.

An average thickness (t₁) of the first external electrodes 31a and 32a formed on the third or fourth end surfaces may be 10 μm or less.

An average thickness (t₂) of the first external electrodes 31a and 32a formed on the first and second main surfaces may be 2 to 10 μm.

An average thickness (t₃) of the second external electrodes 31b and 32b may be 5 to 15 μm.

The first external electrodes 31a and 32a may contain a conductive metal having a content of 60 wt % or less based on the total weight thereof, wherein the conductive material may be at least one selected from a group consisting of copper (Cu), nickel (Ni), silver (Ag), and sliver-palladium (Ag—Pd).

In the length direction of the ceramic body 10, when a total length of the external electrodes 31 and 32 is L and a length of the second external electrodes 31b and 32b is E, 0.05≦E/L≦0.3 may be satisfied.

Plating layers may further be formed on the external electrodes 31 and 32.

Hereinafter, the multilayered ceramic electronic component according to the embodiment of the present invention will be described. Particularly, a multilayered ceramic capacitor will be described, but the present invention is not limited thereto.

The ceramic body 10 may have a hexahedral shape. In the present embodiment, end surfaces in the stacking direction will be defined as first and second main surfaces Tf and Bf, end surfaces in the length direction will be defined as third and fourth end surfaces Sf1 and Sf2, and end surfaces in the width direction will be defined as fifth and sixth side surfaces Lf1 and Lf2.

Meanwhile, in the multilayered ceramic capacitor according to the embodiment of the present invention, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1. Here, the ‘thickness direction’ is the same as a direction in which dielectric layers are stacked, that is, the ‘stacking direction’.

According to the embodiment of the present invention, a raw material forming the dielectric layer 1 is not particularly limited as long as sufficient capacitance may be obtained, but may be, for example, a barium titanate (BaTiO₃) powder.

In a material forming the dielectric layer 1, various ceramic additives, organic solvents, plasticizers, binders, dispersing agents, and the like, may be applied to a powder such as a barium titanate (BaTiO₃) powder, or the like, according to the purposes of the present invention.

A material forming the internal electrodes 21 and 22 is not particularly limited, but may be a conductive paste formed of at least one of, for example, silver (Ag), lead (Pg), platinum (Pt), nickel (Ni), and copper (Cu).

The multilayered ceramic capacitor according to the embodiment of the present invention may include the external electrodes 31 and 32 electrically connected to the internal electrodes 21 and 22.

The external electrodes 31 and 32 may be electrically connected to the internal electrodes 21 and 22 in order to form capacitance.

In addition, formation positions of the external electrodes 31 and 32 are not particularly limited as long as the external electrodes 31 and 32 may be electrically connected to the internal electrodes 21 and 22. For example, as shown in the cross-section of FIG. 2, taken along line B-B′ of FIG. 1, one 31 of the external electrodes may be formed on the first and second main surfaces and the third end surface, and the other 32 thereof may be formed on the first and second main surfaces and the fourth end surface, respectively.

According to the embodiment of the present invention, in the length-thickness cross section of the ceramic body, the external electrodes 31 and 32 may include first external electrodes 31a and 32a formed from the third or fourth end surfaces to the first and second main surfaces, and second external electrodes 31b and 32b formed on the first external electrodes 31a and 32a from the third or fourth end surfaces to the first and second main surfaces, having a length shorter than a length to which the first external electrodes are formed on the first and second main surfaces, and containing an epoxy resin.

The first external electrodes 31a and 32a may be formed of the same conductive material as that of the internal electrode, but are not limited thereto. For example, the first external electrodes may be formed of at least one selected from a group consisting of copper (Cu), nickel (Ni), silver (Ag), and sliver-palladium (Ag—Pd).

In addition, the first external electrodes 31a and 32a are not particularly limited, but may contain a conductive metal having a content of 60 wt % or less based on the total weight thereof.

The first external electrodes 31a and 32a may be formed by applying a conductive paste prepared by adding glass frit to the conductive metal powder and then firing the applied conductive paste.

In addition, the external electrodes 31a and 32a may be disposed, for example, on one surface of the ceramic body 10 to form an arc prevention gap, but are not limited thereto.

The second external electrodes 31b and 32b may be formed on the first external electrodes 31a and 32a in the length-thickness cross-section of the ceramic body 10 from the third or fourth end surface to the first and second main surfaces and have the length smaller than the length to which the first external electrodes 31a and 32a are formed on the first and second main surfaces.

Further, the second external electrodes 31b and 32b are not particularly limited, but may include, for example, the epoxy resin.

As described above, the second external electrodes 31b and 32b are formed on the first external electrodes 31a and 32a to suppress a plating solution from infiltrating into the internal electrode, such that the high capacitance multilayered ceramic electronic component having excellent reliability even in the case in which an external electrode is relatively thinned may be implemented.

More specifically, the first external electrodes 31a and 32a may be electrically connected to the internal electrodes 21 and 22 in order to form capacitance, and the second external electrodes 31b and 32b may be formed on the first external electrodes 31a and 32b, such that infiltration of the plating solution into the internal electrodes may be suppressed at the time of forming the plating layers on the second external electrodes 31b and 32b.

However, the second external electrodes 31b and 32b may have the length smaller than the length to which the first external electrodes 31a and 32a are formed on the first and second main surfaces in consideration of a deviation in the thickness of the external electrodes 31 and 32.

More specifically, the length to which the second external electrodes 31b and 32b are formed on the first and second main surfaces is not particularly limited, but may be appropriately set to implement the purpose of the present invention.

Referring to FIG. 2, in the length direction of the ceramic body 10, when a total length of the external electrodes 31 and 32 is L and a length of the second external electrodes is E, the following Equation: 0.05≦E/L≦0.3 may be satisfied.

That is, E/L is controlled to satisfy the following Equation: 0.05≦E/L≦0.3 between the total length of the external electrodes and the length of the second external electrodes, such that the infiltration of the plating solution may be prevented and at the same time, the thickness of the external electrodes may be uniformly maintained.

In a case in which E/L is smaller than 0.05, the plating solution may infiltrate into a relatively thin portion of the external electrodes, such that product reliability may be reduced.

Meanwhile, in a case in which E/L is larger than 0.3, the thickness of the external electrodes becomes relatively, excessively thick, such that a micro multilayered ceramic capacitor may not be implemented.

Meanwhile, according to the embodiment of the present invention, the average thickness (t₁) of the first external electrodes 31a and 32a formed on the third or fourth end surfaces is not particularly limited, but may be, for example, 10 μm or less.

The average thickness (t₁) of the first external electrodes 31a and 32a formed on the third or fourth end surfaces is not particularly limited as long as the first external electrodes 31a and 32a may be electrically connected to the internal electrodes 21 and 22 in order to form capacitance.

In the case in which the average thickness (t₁) of the first external electrodes 31a and 32a formed on the third or fourth end surfaces is thicker than 10 μm, the thickness of the second external electrodes 31b and 32b formed on the first external electrodes 31a and 32a may be relatively low, or the total thickness of the external electrodes may be relatively high.

Meanwhile, the average thickness (t₂) of the first external electrodes 31a and 32a formed on the first and second main surfaces may be 2 to 10 μm.

In the case in which the average thickness (t₂) of the first external electrodes 31a and 32a formed on the first and second main surfaces is thinner than 2 μm, the thickness is excessively thin, such that the total thickness of the external electrodes may be non-uniform.

In the case in which the average thickness (t₂) of the first external electrodes 31a and 32a formed on the first and second main surfaces is thicker than 10 μm, the thickness is excessively thick, such that the micro multilayered ceramic capacitor may not be implemented.

The average thickness (t₃) of the second external electrodes 31b and 32b formed on the first external electrodes 31a and 32a may be 5 to 15 μm, but is not limited thereto.

According to the embodiment of the present invention, the average thickness (t₃) of the second external electrodes 31b and 32b is controlled to be in a range of 5 to 15 μm, such that the thickness of the external electrodes may be uniformly controlled and infiltration of the plating solution into the internal electrodes may be suppressed.

In the case in which the average thickness (t₃) of the second external electrodes 31b and 32b is thinner than 5 μm, the plating solution may infiltrate into the internal electrodes, such that reliability may be reduced.

In the case in which the average thickness (t₃) of the second external electrodes 31b and 32b is thicker than 15 μm, the total thickness of the external electrodes becomes high, such that it may be difficult to implement the micro multilayered ceramic capacitor.

The average thicknesses of the first external electrodes 31a and 32a and the second external electrodes 31b and 32b may be measured from an image obtained by scanning a cross section of the ceramic body 10 in the length direction using a scanning electron microscope (SEM) as shown in FIG. 2.

For example, thicknesses at 30 equidistant points in the thickness direction of the ceramic body with respect to the first external electrodes 31a and 32a and the second external electrodes 31b and 32b may be measured from the image obtained by scanning the cross-section of the ceramic body 10 in the length-thickness (L-T) direction taken in a central portion of the ceramic body 10 in the width (W) direction, using a scanning electron microscope (SEM), thereby measuring the average value, as shown in FIG. 2.

A multilayered ceramic electronic component according to another embodiment of the present invention may include; a ceramic body 10 including a dielectric layer 1 and having first and second main surfaces opposing each other in a stacking direction of the dielectric layer 1, third and fourth end surfaces connecting the first and second main surfaces to each other and opposing each other in a length direction, and fifth and sixth side surfaces connecting the first and second main surfaces to each other and opposing each other in a width direction; internal electrodes 21 and 22 disposed to face each other in the ceramic body 10, having the dielectric layer 1 therebetween; and external electrodes 31 and 32 electrically connected to the internal electrodes 21 and 22, wherein in the length-thickness cross-section of the ceramic body 10, the external electrodes 31 and 32 may include first external electrodes 31a and 32a formed from the third or fourth end surfaces to the first and second main surfaces, and second external electrodes 31b and 32b formed on the first external electrodes 31a and 32a and containing an epoxy resin. Here, when a total length of the external electrodes 31 and 32 is L and a length of the second external electrodes 31b and 32b is E, in the length direction of the ceramic body 10, 0.05≦E/L≦0.3 may be satisfied.

The multilayered ceramic electronic component according to another embodiment of the present invention has the same features as those of the multilayered ceramic electronic capacitor according to the embodiment of the present invention described above except for a ratio of the total length of the external electrodes to the length of the second external electrodes. Therefore, a description thereof will be omitted.

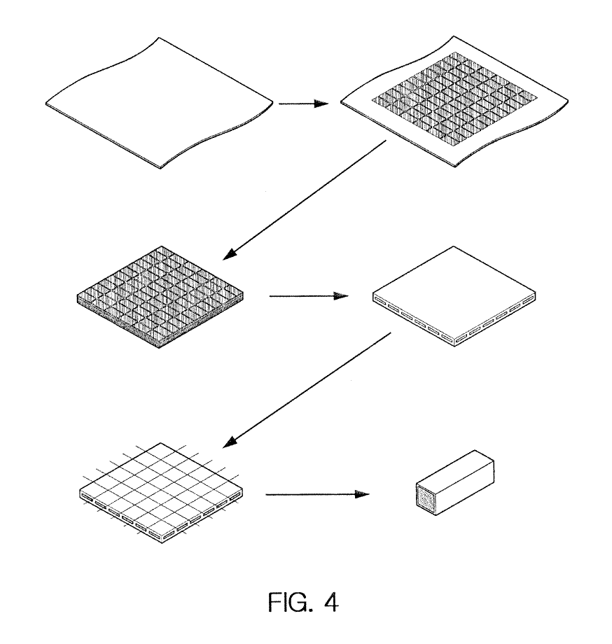

FIG. 4 is a view illustrating a manufacturing process of the multilayered ceramic capacitor according to another embodiment of the present invention.

Referring to FIG. 4, a method of manufacturing the multilayered ceramic electronic component according to another embodiment of the present invention may include: preparing a ceramic body including dielectric layers and a plurality of internal electrodes disposed to face each other and having the dielectric layer interposed therebetween; preparing a conductive paste for an external electrode containing a conductive metal; applying the conductive paste for an external electrode to an end portion of the ceramic body to be electrically connected to the internal electrodes to thereby form first external electrodes; forming second external electrodes containing an epoxy resin on the first external electrodes; and firing the ceramic body to form external electrodes, wherein in a length direction of the ceramic body, when a total length of the external electrodes is L and a length of the second external electrodes is E, 0.05≦E/L≦0.3 may be satisfied.

Hereinafter, the method of manufacturing the multilayered ceramic electronic component according to another embodiment of the present invention will be described. Particularly, a method of manufacturing a multilayered ceramic capacitor will be described, but the present invention is not limited thereto.

In addition, a description of features overlapped with those of the multilayered ceramic electronic component according to the embodiment of the present invention described above will be omitted.

The multilayered ceramic capacitor according to the present embodiment may be prepared as follows.

First, a slurry containing a powder such as a barium titanate (BaTiO₃) powder, or the like, is applied to a carrier film and dried to prepare a plurality of ceramic green sheets, thereby forming a dielectric layer.

The plurality of ceramic green sheets may be set to have a thickness so that an average thickness of the dielectric layer after firing becomes 1.0 μm.

Next, a conductive paste for an internal electrode in which an average size of a nickel particle is 0.05 to 0.2 μm is prepared.

The conductive paste for an internal electrode is applied to the green sheet by a screen printing method to form an internal electrode and the green sheets are then stacked to form a multilayer body.

Then, the multilayer body is compressed and cut to form a chip having a 1005 standard size (length×width×thickness is 1.0 mm×0.5 mm×0.5 mm), and the chip is fired at a temperature of 1050 to 1200° C. under a reducing atmosphere in which H2 is 0.1% or less, thereby preparing a ceramic body.

Next, the conductive paste for an external electrode containing the conductive metal is prepared and is applied to the end portion of the ceramic body to be electrically connected to the internal electrodes, thereby forming first external electrodes.

The first external electrodes may be prepared by dipping both of the end portions of the ceramic body into the conductive paste for an external electrode, but is not limited thereto. For example, the first external electrodes may be manufactured by various methods.

The first external electrodes may be controlled so that an average thickness of a portion thereof formed on a third or fourth end surface of the ceramic body is 10 μm or less. Here, a control of the thickness is not particularly limited, and a method of cutting a portion of the formed first external electrode may be applied.

Next, second external electrodes containing an epoxy resin may be formed on the first external electrodes.

A method of forming the second external electrodes may be performed by the same method as that of the first external electrodes, and particularly, be performed with a dipping method.

Then, a multilayered ceramic capacitor may be prepared through a process such as a plating process, and the like, on the second external electrodes.

In the multilayered ceramic electronic component manufactured by a method of manufacturing multilayered ceramic electronic component according to the embodiment of the present invention, the plating solution may be suppressed from infiltrating into the internal electrodes, thereby having the excellent reliability even in the case in which the external electrode is relatively thinned.

As set forth above, according to embodiments of the present invention, a high capacitance multilayered ceramic electronic component capable of suppressing infiltration of a plating solution into an internal electrode to have excellent reliability even in the case in which an external electrode is relatively thin may be implemented.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic body including a dielectric layer and having first and second main surfaces opposing each other in a stacking direction of the dielectric layer, third and fourth end surfaces connecting the first and second main surfaces to each other and opposing each other in a length direction, and fifth and sixth side surfaces connecting the first and second main surfaces to each other and opposing each other in a width direction;
internal electrodes disposed to face each other in the ceramic body and having the dielectric layer interposed therebetween; and
external electrodes electrically connected to the internal electrodes,
in the length-thickness cross-section of the ceramic body, the external electrodes including first external electrodes formed from the third or fourth end surface to the first and second main surfaces, and second external electrodes formed from the third or fourth end surfaces to the first and second main surfaces on the first external electrodes, having a length shorter than a length to which the first external electrodes are formed on the first and second main surfaces, and containing an epoxy resin.

2. The multilayered ceramic electronic component of claim 1, wherein the first external electrode formed on the third or fourth end surface has an average thickness of 10 μm or less.

3. The multilayered ceramic electronic component of claim 1, wherein the first external electrode formed on the first and second main surfaces has an average thickness of 2 to 10 μm.

4. The multilayered ceramic electronic component of claim 1, wherein the second external electrode has an average thickness of 5 to 15 μm.

5. The multilayered ceramic electronic component of claim 1, wherein the first external electrode contains a conductive metal having a content of 60 wt % or less based on the total weight thereof.

6. The multilayered ceramic electronic component of claim 5, wherein the conductive metal is at least one selected from a group consisting of copper (Cu), nickel (Ni), silver (Ag), and sliver-palladium (Ag—Pd).

7. The multilayered ceramic electronic component of claim 1, wherein in the length direction of the ceramic body, when a total length of the external electrode is L and a length of the second external electrode is E, 0.05≦E/L≦0.3 is satisfied.

8. The multilayered ceramic electronic component of claim 1, further comprising a plating layer formed on the external electrode.

9. A multilayered ceramic electronic component comprising:
a ceramic body including a dielectric layer and having first and second main surfaces opposing each other in a stacking direction of the dielectric layer, third and fourth end surfaces connecting the first and second main surfaces to each other and opposing each other in a length direction, and fifth and sixth side surfaces connecting the first and second main surfaces to each other and opposing each other in a width direction;
internal electrodes disposed to face each other in the ceramic body and having the dielectric layer interposed therebetween; and
external electrodes electrically connected to the internal electrodes,
in the length-thickness cross-section of the ceramic body, the external electrodes including first external electrodes formed from the third or fourth end surface to the first and second main surfaces, and second external electrodes formed on the first external electrodes and containing an epoxy resin, and when a total length of the external electrode is L and a length of the second external electrode is E in the length direction of the ceramic body, 0.05≦E/L≦0.3 being satisfied.

10. The multilayered ceramic electronic component of claim 9, wherein the first external electrode formed on the third or fourth end surface has an average thickness of 10 μm or less.

11. The multilayered ceramic electronic component of claim 9, wherein the first external electrode formed on the first and second main surfaces has an average thickness of 2 to 10 μm.

12. The multilayered ceramic electronic component of claim 9, wherein the second external electrode has an average thickness of 5 to 15 μm.

13. The multilayered ceramic electronic component of claim 9, wherein the first external electrode contains a conductive metal having a content of 60 wt % or less based on the total weight thereof.

14. A method of manufacturing a multilayered ceramic electronic component, comprising:
preparing a ceramic body including dielectric layers and a plurality of internal electrodes disposed to face each other and having the dielectric layer interposed therebetween;
preparing a conductive paste for an external electrode containing a conductive metal;
applying the conductive paste for an external electrode to an end portion of the ceramic body to be electrically connected to the internal electrodes to thereby form first external electrodes;
forming second external electrodes containing an epoxy resin on the first external electrodes; and
firing the ceramic body to form the external electrodes,
in a length direction of the ceramic body, when a total length of the external electrode is L and a length of the second external electrode is E, 0.05≦E/L≦0.3 being satisfied.

15. The method of claim 14, wherein the first external electrode formed on the third or fourth end surface has an average thickness of 10 μm or less.

16. The method of claim 14, wherein the first external electrode formed on the first and second main surfaces has an average thickness of 2 to 10 μm.

17. The method of claim 14, wherein the second external electrode has an average thickness of 5 to 15 μm.

18. The method of claim 14, wherein the second external electrode is formed by a dipping method.
